(19) United States
(12) Patent Application Publication
(10) Pub. No.: US 2025/0245418 A1
(43) Pub. Date: Jul. 31, 2025

(54) Hierarchical Tree-Based Attention for Computationally Efficient Language Processing

(71) Applicant: Himakara Nayanajith Pieris, Richmond, CA (US)

(72) Inventor: Himakara Nayanajith Pieris, Richmond, CA (US)

(21) Appl. No.: 19/037,200

(22) Filed: Jan. 25, 2025

Related U.S. Application Data
(60) Provisional application No. 63/625,098, filed on Jan. 25, 2024.

(51) Int. Cl. G06F 40/137; G06F 40/169; G06F 40/205; G06F 40/258; G06F 40/284; G06F 40/30

(52) U.S. Cl. CPC G06F 40/137; G06F 40/169; G06F 40/205; G06F 40/258; G06F 40/284; G06F 40/30

(57) ABSTRACT

This invention introduces a Hierarchical Tree-Based Attention (HTA) mechanism to optimize transformer-based large language models (LLMs) for processing hierarchical documents. HTA leverages a lineage-based approach to model parent-child and sibling relationships, preserving document hierarchy while reducing memory and computational demands. A novel data processing pipeline segments content into blocks, establishes hierarchical relationships, and produces annotated input for LLMs. During attention calculation, embeddings for lineage-related blocks compress information outside the immediate hierarchy, ensuring scalability without sacrificing accuracy. HTA enables efficient applications in structured document processing, such as legal, healthcare, and education, while improving generative tasks like summarization and question answering. This approach advances hierarchical NLP with superior fidelity and reduced latency.

### CROSS-REFERENCE TO RELATED APPLICATIONS

This application claims the benefit of U.S. Provisional Application No. 63/625,098, filed on Jan. 25, 2024, entitled “Hierarchical Tree-Based Attention for Computationally Efficient Language Processing,” which is incorporated herein by reference in its entirety.

In response to the limitations of fixed window attention, sliding window attention mechanisms emerged. These mechanisms aim to mitigate some of the constraints associated with fixed window approaches by expanding the effective context window to process larger documents more efficiently. However, despite these improvements, sliding window attention mechanisms have not adequately captured and represented hierarchical relationships within content. This shortfall is often reflected in the generation of long-form content that lacks structural cohesion and fails to accurately represent complex document constructs.

The innovation presented in this patent application introduces a hierarchical tree attention mechanism that addresses these limitations. Distinguished from the prior art, this mechanism is specifically designed to process large documents efficiently, significantly reducing memory and computational demands. This efficiency is particularly valuable in business environments where cost considerations are crucial. Moreover, this mechanism enhances the quality of generated content by understanding and preserving hierarchical relationships within structured documents. It achieves this by identifying and processing various roles and relationships between content blocks, such as parent-child and sibling relationships. This approach provides a nuanced and context-aware generation of content, diverging from hierarchical transformers designed primarily for classification tasks. Instead, it is geared towards content generation, offering a new dimension of efficiency and fidelity in generative tasks.

In conclusion, the innovation outlined in this patent application represents a significant advancement over existing attention mechanisms. It offers a solution that balances computational efficiency with the capability to produce high-quality content, especially in contexts requiring an understanding of hierarchical document structures.

### SUMMARY OF THE INVENTION

The invention introduces a Hierarchical Tree Attention mechanism, an innovative approach within the domain of large language models, particularly tailored to enhance the understanding of hierarchical relationships in content. This mechanism is designed to operate with reduced memory and compute requirements and generate higher quality content.

Central to this invention is a data processing pipeline crafted for preparing training and inference content for the language model. This pipeline includes a novel data preparation process encompassing steps for discovering content blocks and their lineage.

Incorporated within this invention is a transformer-based large language model equipped with a novel attention mechanism; this novel attention mechanism is capable of compressing information contained in content blocks outside of the direct lineage of a given block to operate with significantly lower memory and compute demands.

This invention, with its hierarchical tree attention mechanism, represents a significant advancement in the field of natural language processing. It addresses the current limitations in handling large documents and complex content structures, offering a more efficient and effective approach to content generation in large language models.

### INDUSTRIAL APPLICABILITY

The Hierarchical Tree-Based Attention (HTA) mechanism is broadly applicable in industries requiring efficient processing and generation of large, structured documents. The invention addresses challenges in natural language processing (NLP) by offering computational efficiency, content fidelity, and scalability. Specific applications include:

Healthcare: Automating the processing of medical records and clinical reports to identify and summarize hierarchical information such as patient histories or test results.

Legal: Analyzing and summarizing lengthy contracts, legal briefs, or case files by leveraging HTA's ability to preserve hierarchical relationships between clauses and sections.

Research and Academia: Synthesizing academic papers and research reports, allowing for the generation of structured summaries while maintaining the integrity of hierarchical information.

Education: Generating hierarchical educational materials, such as syllabi, textbooks, or instructional guides, with structured introductions, bodies, and conclusions.

Enterprise Documentation: Automating the generation and analysis of corporate reports, policy documents, and technical manuals, ensuring scalability and precision.

The invention's ability to efficiently process hierarchical content while minimizing memory and compute demands makes it invaluable for industries reliant on complex document workflows.

### BRIEF DESCRIPTION OF THE DRAWINGS

FIG. 1.0—A document with a hierarchical content block structure with numbered header markings is shown.

FIG. 2.0—Illustration of content blocks delineated from the document stored in a data structure. Includes numbered header markers for ordering the content blocks inside the lineage.

FIG. 3.0—A document with a hierarchical content block structure without numbered header markings is shown.

FIG. 4.0—Illustration of content blocks delineated from the document stored in a data structure.

FIG. 5.0—Illustration of a data structure where content blocks are mapped to clusters as an intermediate step for building content block lineages within the document.

FIG. 6.0—Illustration of a data structure where each content block is indicated with its role within the document.

FIG. 7.0—An illustration of a data structure where various lineages present within a document and their content blocks in the proper order is shown.

FIG. 8.0—Re-produced document with lineage annotations on content blocks are shown.

FIG. 9.0—Transformer architecture—embedding generation phase is identified.

FIG. 10—Transformer architecture—attention calculation phase is identified.

### DETAILED DESCRIPTION OF THE INVENTION

This invention presents a Hierarchical Tree Attention (HTA) mechanism within transformer-based large language models (LLMs), along with a process for pre-processing input data to support HTA. This method significantly enhances the processing of hierarchical content relationships. The invention is focused on delivering better memory and compute efficiency while producing higher-quality content output.

### Pre-Processing Training and Inference Input Data:

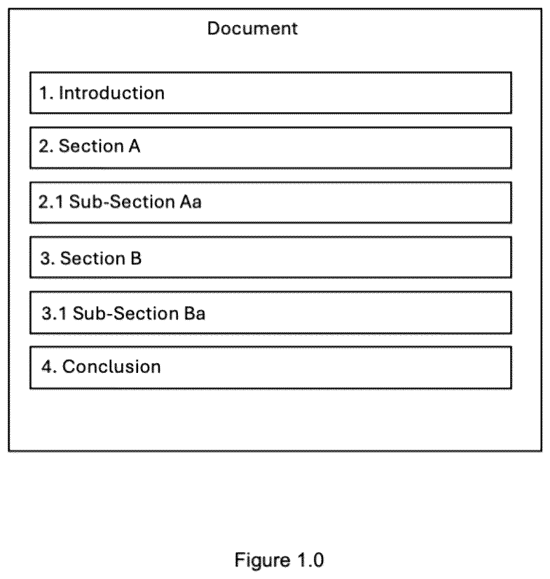

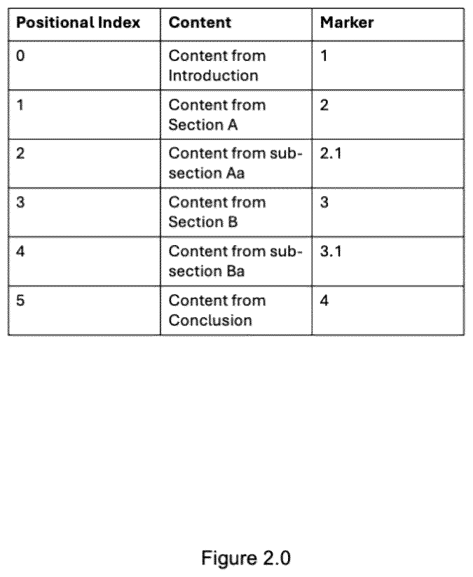

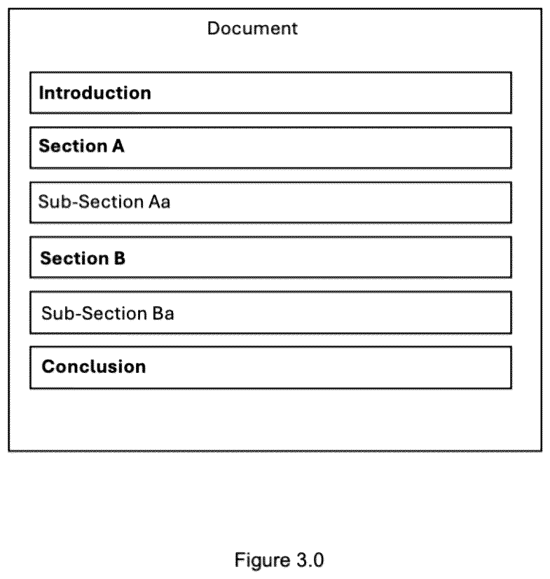

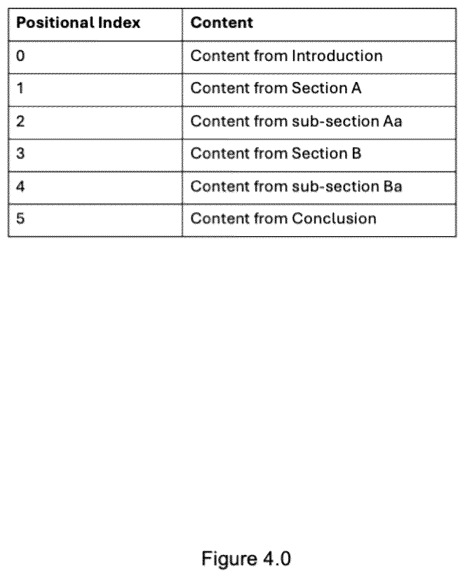

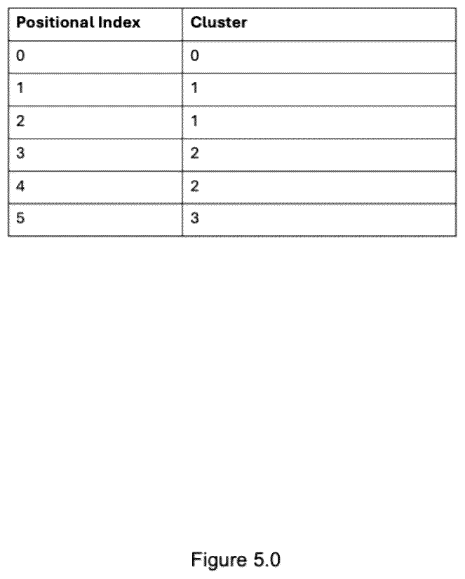

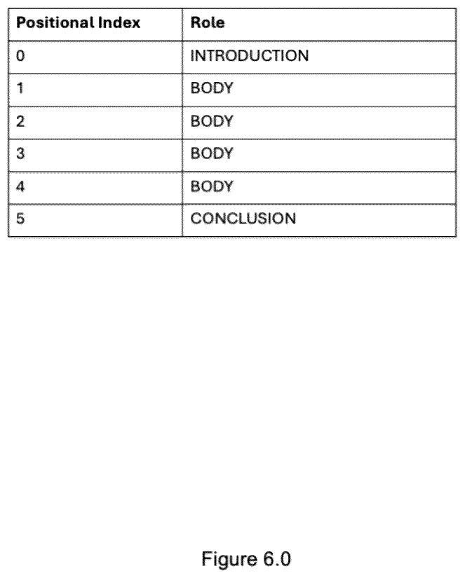

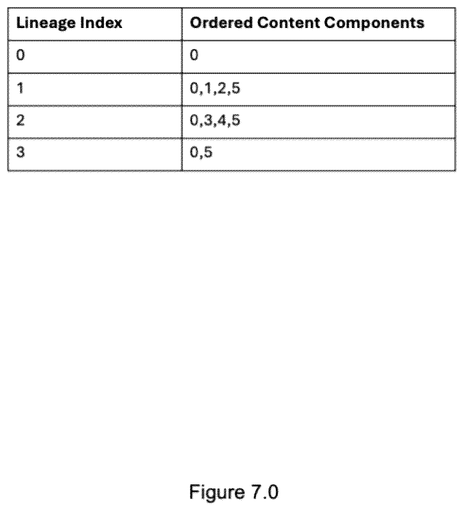

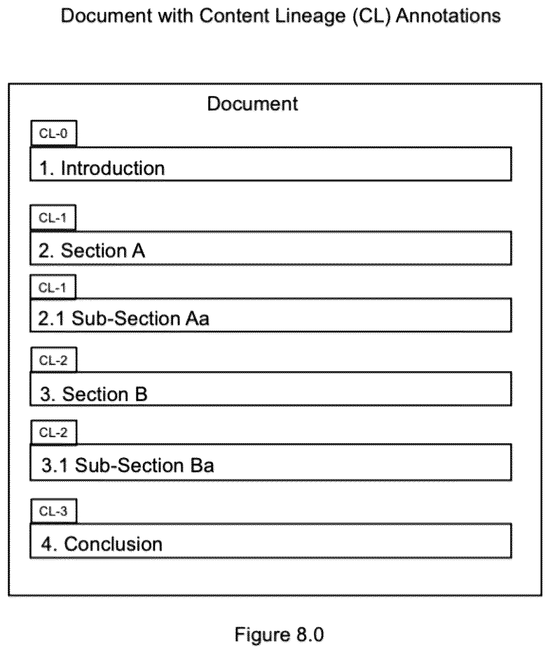

Step 1. Content input, such as a document, is received.
Step 2. Using regular expressions, the document is parsed to identify section heading markers (e.g., 1, 1.1, 1.2, etc.). A series of content blocks are derived from the document using identified section heading markers as content block boundaries. These content blocks are stored in the computer memory in a dictionary-like data structure. (see FIG. 1.0 and FIG. 2.0).
Step 3. In the absence of heading markers, the document is analyzed for visual cues (e.g., font size, weight) to delineate content blocks. A series of content blocks are derived from the document. which are then stored in the computer memory in a dictionary-like data structure (see FIG. 3.0 and FIG. 4.0). Numbered heading markers may be used in conjunction with visual queues in documents where clear visual queues are present in addition to numbered heading markers.
Step 4. If neither headings nor visual cues are present, the text is divided at fixed word intervals, maintaining a 20% overlap between consecutive blocks.
Step 5. Content blocks of the same lineage are identified based on the title numbers if present, text style discrimination if viable or by clustering based on vector distance calculation using models like but not limited to TF-IDF or BERT embeddings, and applying semantic similarity measures such as Cosine similarity for relevance (See FIG. 5.0).
Step 6. A lightweight discriminator model is used to identify the role of each content block within the document. The role may include but not limited to INTRODUCTION, BODY, and CONCLUSION. This data is stored in the computer memory (See FIG. 6.0)
Step 7. A hierarchy of content blocks is formed to establish the lineage. If heading markers were present in the input text, hierarchy is established based on the numbering provided in the heading markers. If no heading markers were present in the input text, clustering output is used. Within each cluster, sorting is performed based on the order of appearance in the input text to establish the hierarchy of content. Furthermore, the identified content block role is used to prefix and suffix the lineage with the introduction and conclusion block if present (see FIG. 7.0).
Step 8. An annotated copy of the content input is created, marked with content block identification and lineage identification (see FIG. 8.0).

### Attention Handling in the Transformer-Based Model:

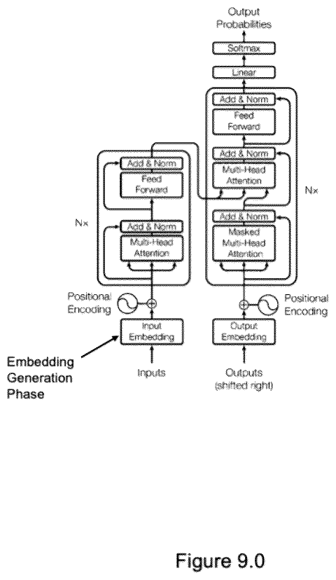

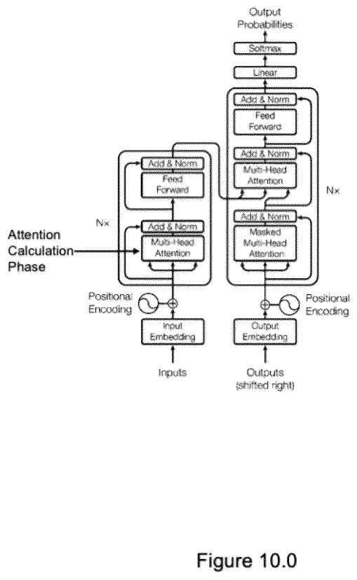

Step 9. During the embedding generation phase (see FIG. 9.0) annotated document is used as the input, embeddings for individual words/word fragments (i.e., tokens) and content blocks are created. Annotations from pre-processing are masked to focus on the content substance.
Step 10. During the attention calculation phase (see FIG. 10.0) Attention calculation is performed for each token by considering its embedding and those of preceding tokens in its lineage, as well as embeddings of preceding sibling content blocks. This approach reduces memory and compute usage by leveraging the embeddings of entire sibling content blocks rather than individual tokens within them.

The HTA mechanism and the associated data processing pipeline are unique to this invention, enabling it to process large documents and complex structures with improved efficiency compared to existing LLMs. This advancement offers a substantial contribution to the field of natural language processing.

### PATENT CITATIONS AND REFERENCE

The invention builds upon existing developments in natural language processing and transformer-based architectures. The following patents and publications are relevant to the field and highlight the novelty of the current invention:

### PATENT CITATIONS

2. U.S. Pat. No. 11,615,240B2.
   Title: Systems and Methods for a Transformer Network with Tree-Based Attention for Natural Language Processing
   Inventor(s): Xuan Phi Nguyen, Shafiq Rayhan Joty, Chu Hong Hoi
   Assignee: Salesforce, Inc.
   Filing Date: Sep. 24, 2019
   Summary:
   This patent introduces a tree-based attention mechanism for transformer architectures, enabling hierarchical encoding of pre-parsed constituency trees in a bottom-up manner. It integrates processes such as hierarchical embedding, accumulation, and subtree masking into transformer self-attention and cross-attention mechanisms. The invention improves transformer performance for hierarchical NLP tasks such as machine translation and text classification.
   Distinction:
   Unlike U.S. Pat. No. 11,615,240B2, which relies on pre-parsed constituency trees and subtree masking to encode sentence-level hierarchical structures, the present invention dynamically identifies hierarchical relationships in document-level content without pre-parsing. It leverages lineage-based embeddings to optimize memory and computation, making it suitable for processing large-scale structured documents.
3. CN111159416B
   Title: Language task model training method and device, electronic equipment and storage medium
   Assignee: Tencent Technology Shenzhen Co Ltd
   Filing Date: Apr. 2, 2020
   Summary:
   Describes methods for training language models with task-specific optimizations, including hierarchical pre-training, forward propagation, and backpropagation. Techniques include progressive layer-wise updates and corpus-based learning rate adjustments for improving model accuracy and performance.
   Distinction:
   This invention focuses on optimizing model training for specific language tasks, whereas the current invention dynamically processes document-level hierarchical relationships using lineage-based embeddings during inference. Additionally, the proposed invention targets memory and computation efficiency for large-scale document processing, distinguishing it from CN111159416B's training-oriented approach.

### Non-Patent Literature

2. “Attention Is All You Need” (Vaswani et al., 2017)
   Describes the foundational transformer architecture and attention mechanism but focuses on fixed and sliding window approaches without hierarchical modeling.
3. “Longformer: The Long-Document Transformer” (Beltagy et al., 2020)·
   Introduces sparse attention for long documents but does not address hierarchical attention or lineage-based relationships.
4. “Hierarchical Attention Networks for Document Classification” (Yang et al., 2016)·
Explores hierarchical attention for classification tasks but lacks applicability to generative NLP tasks and lineage-based embeddings.

1: A method for processing hierarchical content in a transformer-based large language model, comprising:
parsing input text into content blocks based on predefined heading markers, visual cues, or clustering techniques;
establishing hierarchical relationships among content blocks, including parent-child and sibling relationships;
calculating attention using embeddings for individual tokens within a content block and embeddings of sibling content blocks; and
reducing computational complexity by compressing information outside the lineage of a given content block.

2: The method of claim 1, wherein the hierarchical relationships are established using a combination of semantic similarity measures and/or visual analysis.

3: The method of claim 1, wherein the transformer model generates embeddings for content blocks based on lineage annotations during the embedding phase.

4: A data processing pipeline for preparing hierarchical input data for transformer-based models, comprising:
Identifying and delineating content blocks from documents.
Annotating content blocks with roles and lineage information.
Generating input data annotated for use in hierarchical attention calculations.

5: The method of claim 4, wherein the annotations include role identifiers such as Introduction, Body, and Conclusion.

6: A hierarchical transformer-based language model leveraging content lineage to enhance attention computation, wherein attention for each token includes embeddings from parent, child, and sibling relationships.

7: The method of claim 6, wherein the model is applied to generative NLP tasks, including summarization, question answering, or structured document synthesis.
